(19) United States
(12) Patent Application Publication
(10) Pub. No.: US 2020/0265648 A1
(43) Pub. Date: Aug. 20, 2020

(54) SYSTEMS AND METHODS FOR PROVIDING A VIRTUAL REALITY EXPERIENCE

(71) Applicant: Walmart Apollo, LLC, Bentonville, AR (US)

(72) Inventors: Wyatt M. Thornbury, Marina Del Rey, CA (US); Christopher J. Gaudino, Los Angeles, CA (US)

(21) Appl. No.: 16/787,812

(22) Filed: Feb. 11, 2020

Related U.S. Application Data
(60) Provisional application No. 62/805,779, filed on Feb. 14, 2019.

(51) Int. Cl. G06T 19/00; G02B 27/01; G06T 15/20; G06F 3/01; H04N 13/194; H04N 13/167

(52) U.S. Cl. CPC G06T 19/006; G02B 27/0101; G06T 15/205; G02B 2027/0129; H04N 13/194; H04N 13/167; G06T 2215/16; G06F 3/011

(57) ABSTRACT

In some embodiments, a VR system for providing a VR experience comprises a display device configured to present a VR presentation and a control circuit configured to generate a background VR presentation including only those pixels that are not within a user's sphere during the VR experience, wherein the user's sphere has a radius which extends from the user, determine, based on an analysis of video frames, objects that are not within the user's sphere during the VR experience, generate a foreground VR presentation excluding the objects that are not within the user's frame during the VR experience, render a VR presentation including a real time rendering of the foreground VR presentation wherein the background VR presentation is rendered as an object within the VR presentation, transmit, during the rendering, the VR presentation, and synchronize, during the rendering, the background VR presentation and the foreground VR presentation.

### CROSS-REFERENCE TO RELATED APPLICATION

This application claims the benefit of U.S. Provisional Application No. 62/805,779, filed Feb. 14, 2019, which is incorporated by reference in its entirety herein.

### TECHNICAL FIELD

This invention relates generally to virtual reality experiences and, more particularly, to rendering virtual reality presentations.

### BACKGROUND

Virtual reality experiences allow users to view a virtual world as if it were the real world. Virtual reality experiences can be used for gaming, property tours, movies, etc. Generally, increasing the complexity and number of objects in the virtual world results in a more realistic virtual world and an improved virtual reality experience. While it is desired to make the virtual reality experience as realistic as possible, cost and computing constraints exist. For example, the more complex an object, the more computing power required to render the object in the virtual world. Similarly, as the number of objects to be rendered in the virtual world increases, the computing power required for rendering the virtual world increases. Consequently, a need exists for systems, methods, and apparatuses that can provide more realistic virtual experiences with the computing resources available.

### BRIEF DESCRIPTION OF THE DRAWINGS

Disclosed herein are embodiments of systems, apparatuses, and methods pertaining to providing a virtual reality (“VR”) experience. This description includes drawings, wherein:

FIG. 1 depicts a user's sphere 112 in a virtual reality presentation, according to some embodiments;

FIG. 2 depicts a user 202 within a sphere 204, as well as objects that have different relationships with respect to the sphere 204, according to some embodiments;

FIG. 3 depicts a user 302 traversing a fixed path 314 of a virtual reality experience, according to some embodiments;

FIG. 4 is a block diagram of a system 400 for providing a virtual reality experience, according to some embodiments; and

FIG. 5 is a flow chart depicting example operations for providing a virtual reality experience, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to providing a virtual reality (“VR”) experience. In some embodiments, a VR system for providing a VR experience comprises a display device, wherein the display device is configured to present a VR presentation, and a control circuit, wherein the control circuit is communicatively couples to the display device, and wherein the control circuit is configured to generate a background VR presentation, wherein the background VR presentation includes only those pixels that are not within a user's sphere during the VR experience, wherein the user's sphere has a radius which extends from the user during the VR experience, determine, based on an analysis of video frames, objects that are not within the user's sphere during the VR experience, generate a foreground VR presentation, wherein the foreground VR presentation excludes the objects that are not within the user's frame during the VR experience, render a VR presentation, wherein the VR presentation includes a real time rendering of the foreground VR presentation, and wherein the background VR presentation is rendered as an object within the VR presentation, transmit, during the rendering of the VR presentation to the display device for presentation, the VR presentation, and synchronize, during the rendering of the VR presentation, the background VR presentation and the foreground VR presentation.

As previously discussed, the more realistic a virtual world, the more realistic the virtual experience. Accordingly, there is a desire to create virtual worlds that appear as realistic as possible. It should be noted that the term realistic does not necessarily imply that the virtual world must look like the “real world” (i.e., the world as it currently exists). Rather, the term realistic is used to describe the degree to which the virtual world appears to be real, as opposed to virtual, to the user. For example, a clearly fictional environment (e.g., an environment including dinosaurs) may not be realistic in the sense that it is not similar to the real world. Rather, the fictional environment would be realistic in that it appears to be real, as opposed to virtual.

The realness of virtual worlds can be improved by increasing the complexity of objects in the virtual world (e.g., increasing the resolution, enhancing the shading, improving the texture, etc. of objects) and/or increasing the number of objects in the virtual world. However, increasing the complexity, as well as the number, of objects in the virtual world increases the computing power required to the render the virtual world. Typically, computing power constraints dictate how complex a virtual world can be. However, even ignoring computing power constraints, monetary considerations may come into play when computing power needs are high.

Typically, virtual worlds are rendered in real time (i.e., real, or substantially real, time as a user experiences the virtual world). The virtual worlds are rendered in real time because the world must be rendered based on the user's interaction with the virtual world. For example, if a person looks to his or her left, the objects of the virtual world that are positioned to his or her left must be rendered. As another example, if the user is interacting with an object in the virtual world, the virtual world must be rendered based on this interaction. Real time rendering requires very quick rendering and thus significant computing power.

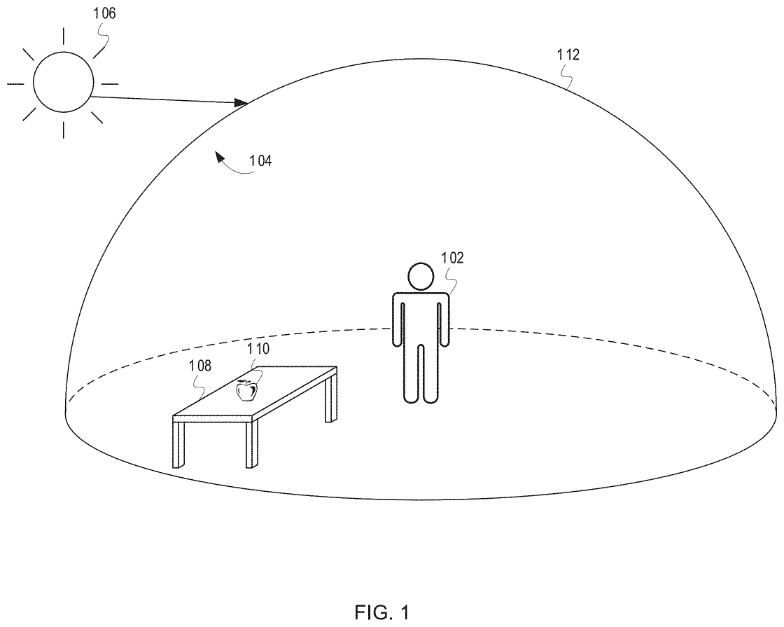

Embodiments of the systems, methods, and apparatuses disclosed herein seek to minimize the computing power required to present a virtual world via the use of prerendering. In one embodiment, portions of the virtual world are prerendered. That is, portions of the virtual world are not rendered in real time. For example, background imagery, such as mountains, trees, the sky, clouds, etc. can be prerendered. The portions of the virtual world that are prerendered do not face the same timing requirements as the real time rendering. For example, if the frame rate of a virtual experience is ninety frames per second, a frame must be rendered in approximately eleven milliseconds for the virtual experience to run smoothly. Because portions of the virtual world are prerendered, those portions need not be rendered in eleven milliseconds. Rather, those portions of the virtual world can be rendered more slowly (e.g. over several seconds, minutes, hours, etc.), thus requiring fewer computing resources for rendering. The prerendered portions are then rendered as objects within the virtual world during presentation. Because the prerendered portions are rendered as objects within the virtual world during presentation, fewer objects need to be rendered in real time, thus decreasing computing power requirements. The discussion of FIG. 1 provides an overview of such virtual presentation generation.

FIG. 1 depicts a user's sphere 112 in a virtual reality presentation, according to some embodiments. During a VR experience, a user 102 can traverse the virtual world. Dependent upon the embodiment, the user 102 may be able to roam the virtual world freely, proceed through the virtual world on a predetermined (i.e., fixed) path, or simply be present in the virtual world without being able to move within the virtual world (e.g., be able to observe the virtual world from one or more stationary points).

The virtual world is presented via a VR presentation. The VR presentation comprises a background VR presentation and a foreground VR presentation. In the example depicted in FIG. 1, the sun 106 would be included in the background VR presentation and the table 108 and the apple 110 would be included in the foreground VR presentation. Whether an object (e.g., the sun 106, table 108, apple 110, etc.) is included in the background VR presentation or the foreground VR presentation is based on whether the object is within the user's 102 sphere 112.

The sphere 112 (i.e., the user's sphere) is a sphere that extends a distance from the user during the VR presentation. The radius of the sphere 112 can be any suitable distance dependent upon the desired VR experience. In one embodiment, the radius of the sphere 112 is selected such that the user will not experience a parallax effect when viewing objects that are outside of the sphere 112. Though depicted in FIG. 1 as a partial sphere or hemisphere, the sphere 112 an take any suitable form dependent upon, for example, the topography of the virtual world.

The background VR presentation is presented on an inner surface 104 of the sphere 112 (e.g., as a three hundred sixty-degree video). For example, the sun 106 can be presented on the inner surface 104 of the sphere, as well as any other objects included in the background VR presentation. The objects included in the background VR presentation can quite literally be the “background” of the virtual world (e.g., trees, the sky, mountains, etc.). However, embodiments are not so limited. For example, the background VR presentation can include any objects that are outside of the sphere 112 but may not traditionally be referred to as a “background” (e.g., people, automobiles, rocks, animals, etc.).

The background VR presentation is prerendered. That is, the background VR presentation is not rendered at the time of presentation of the VR presentation via a display device (e.g., an immersive display device such as a head mounted display (HIVID) or a traditional display device, such as a television). For example, the background VR presentation can include still or video images of the objects outside of the sphere 112. In the case of a static VR experience (i.e., an experience in which the user 102 cannot traverse the virtual world) still images can be used. Likewise, in the case of a dynamic VR experience (i.e., an experience in which the user 102 can traverse the virtual world whether freely, on a fixed path, or a combination of the two) video images can be used.

In some embodiments, before the background VR presentation is prerendered, a pixel-by-pixel analysis is performed. During the pixel-by-pixel analysis, it is determined which pixels will not be within the sphere 112 during the VR experience. Those pixels that will be within the sphere 112 during the VR experience are excluded from the background VR presentation. Put another way, the background VR presentation includes only those pixels that will not be within the sphere 112 during the VR experience.

The foreground VR presentation is rendered in real, or near real, time and presented to the user as would a traditional VR world. That is, those objects that will be within the sphere 112 during the VR experience are rendered as the user 102 partakes in the VR experience. In some embodiments, before the foreground VR presentation is rendered, a frame-by-frame analysis is performed. During the frame-by-frame analysis, it is determined which objects will not be within the sphere 112 during the VR experience. This includes two categories of objects: 1) objects that will never be within the sphere 112 during the VR experience and 2) objects that will pass through or temporarily be within the sphere 112 during the VR experience. The foreground VR presentation excludes those objects that will not be within the sphere 112 during the VR experience. Put another way, the foreground VR presentation includes only those objects that will be within the sphere 112, at least temporarily, during the VR experience.

As previously discussed, the foreground VR presentation of the example depicted in FIG. 1 includes the table 108 and the apple 110. During the VR experience, the user 102 may be able to interact with some of these objects. For example, the user 102 may be able to pick up or otherwise manipulate the apple 110. However, the user need not be able to interact with all, or any, of the objects in the foreground VR presentation. For example, the user 102 may not be able to lift or move the table 108, but his or her perspective of the table 108 may vary based on his or her movements during the VR experience. For example, if the user 102 crouches, his or her view of the table 108 may change from an above view including, for example, the top of the table 108 to an underneath view including, for example, the underside of the table 108.

As previously discussed, the VR presentation includes both the background VR presentation and the foreground VR presentation. In some embodiments, the background VR presentation is rendered as an object within the VR presentation. For example, much like the table 108 is rendered as an object within the VR presentation, the background VR presentation is rendered as an object within the VR presentation. That is, as the user's 102 perception of the table 108 is dependent upon his or her movement during the VR experience, the user's perception of the background VR presentation is dependent upon his or her movement during the VR experience.

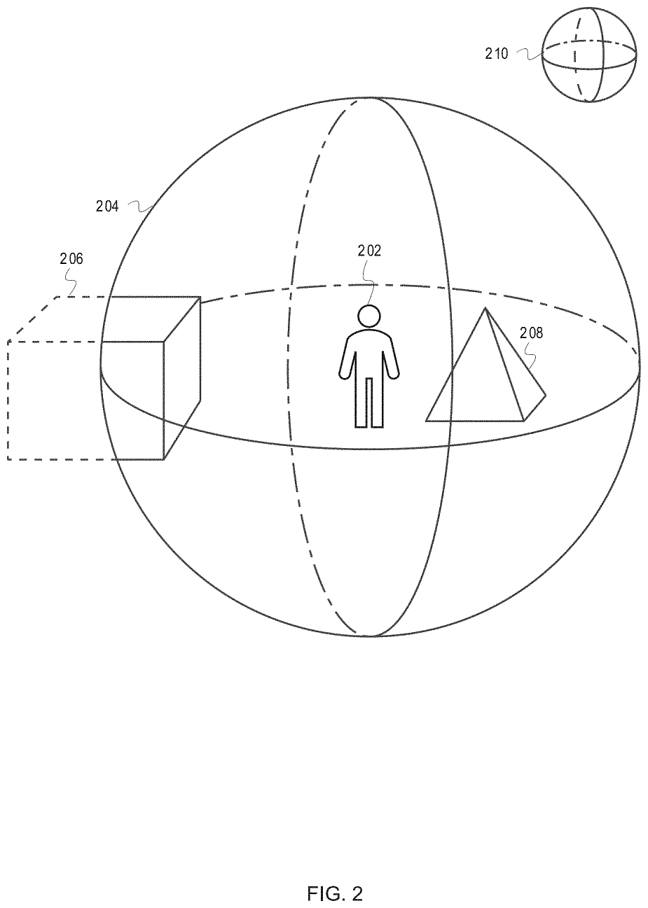

While the discussion of FIG. 1 provides background information regarding a VR presentation in which the background VR presentation is prerendered, the discussion of FIG. 2 provides additional details with respect to the user's sphere and how objects are rendered based on their relationship with the user's sphere.

FIG. 2 depicts a user 202 within a sphere 204, as well as objects that have different relationships with respect to the sphere 204, according to some embodiments. As discussed with respect to FIG. 1, the user's sphere 204 (or simply “sphere”) extends about the user 202 as the user 202 experiences the VR experience. The user's sphere 204 is not a physical sphere and may not even be presented during the VR experience. Rather, the user's sphere is used to determine what objects should be included as part of the background VR presentation and/or what objects should be included as part of the foreground VR experience. In one embodiment, the user's sphere 204 is used as a guide as to which objects can be prerendered. For example, objects that fall outside of the user's sphere 204 are far enough away from the user 202 during the VR experience that real, or near time, rendering of those objects is not required.

The objects of the VR experience fall into three categories: 1) those objects that are always within the user's sphere 204, 2) those objects that are never within the user's sphere 204, and 3) those objects that are partially when the user's sphere 204. The example depicted in FIG. 2 includes three objects: 1) a cube 206, 2) a pyramid 208, and 3) a ball 210. Each of these objects has a different relationship with the user's sphere 204.

The pyramid 208 is represented as being within the user's sphere 204. As a simple example, assume that the VR experience depicted in FIG. 2 is a static VR experience (i.e., a VR experience in which the user 202 cannot move through the virtual world during the VR experience). If the objects in the virtual experience are also stationary, the pyramid 208 will be within the user's sphere 204 during the entirety of the VR experience. Because the pyramid 208 will always be within the user's sphere 204, the pyramid 208 would be part of the foreground VR presentation and thus rendered in real, or near real, time.

The ball 210 is represented as being outside of the user's sphere 204. Again, assuming a static VR experience and that the ball 210 does not move during the VR experience, the ball 210 will be outside of the user's sphere 204 during the entirety of the VR experience. Because the ball 210 will always be outside of the user's sphere 204 (much like the sun described in the example provided in FIG. 1), the ball 210 would be part of the background VR presentation and thus prerendered. As one example, the ball 210 would be part of the background of the VR experience and the background VR presentation, including the ball 210, would be rendered as an object within the VR presentation while the user 202 is partaking in the VR experience.

The cube 206 is represented as being partially within the user's sphere 204, as indicated by the combination of solid and dashed lines. Again, assuming a static VR experience and that the cube 206 does not move during the VR experience, the cube 206 will be both within the user's sphere 204 and outside of the user's sphere 204 during the entirety of the VR experience. Because at least a portion of the cube 206 will be within the user's sphere 204 during the VR experience, at least a portion of the cube 206 will be part of the foreground VR presentation. The portion of the cube 206 that is outside of the user's sphere 204 can be part of the background VR presentation. However, from a synchronization perspective, in some embodiments, the entire cube 206 will be rendered as part of the foreground VR experience.

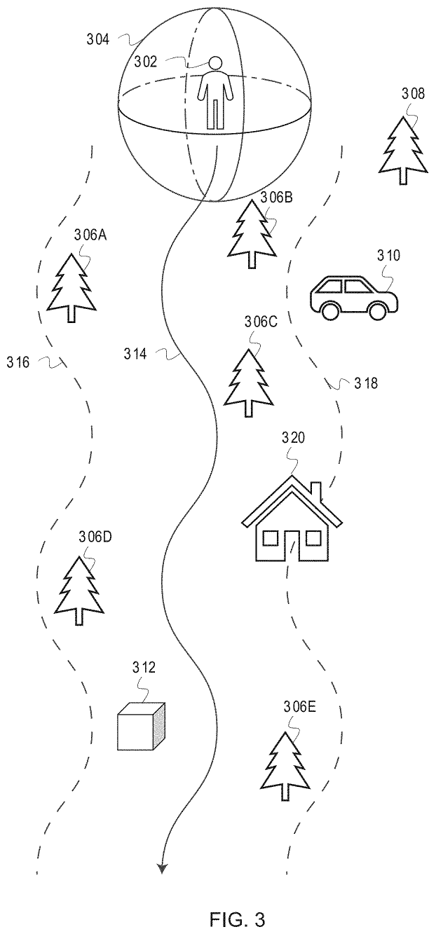

While the discussion of FIG. 2 provides additional detail regarding objects and their relationships with the user's sphere, the discussion of FIG. 3 will describe these concepts with respect to a dynamic VR experience (i.e., a VR experience in which the user can at least partially navigate the virtual world).

FIG. 3 depicts a user 302 traversing a fixed path 314 of a VR experience, according to some embodiments. In the example provided in FIG. 3, the user 302 is partaking in a VR experience that includes a fixed path 314. The user 302 travels through the virtual world via the fixed path 314. The virtual world includes a number of objects, such as first trees 306A-E, a second tree 308, a car 310, a house 320, and a box 312. The objects exist in the virtual world as the user 302 traverse the virtual world via the fixed path 314.

Depicted for clarity, surrounding the user 302 is a user's sphere 304. The user's sphere 304 is representative of a distance from the user 302 in which objects will be part of the foreground VR presentation. The left-right boundaries (with respect to the user's 302 perspective) are marked by hashed lines. The left-right boundaries include a left boundary 318 and a right boundary 316. The left boundary 318 and the right boundary 316 represent the left-right distance from the user 302 which the user's sphere 304 extends. As can be seen, the left boundary 318 and the right boundary 316 are based on the fixed path 314. That is, as the user 302, and thus the user's sphere 304, traverse the fixed path, the left boundary 318 and the right boundary 316 follow.

As previously discussed, the virtual world includes a number of objects. Objects that are between the left boundary 318 and the right boundary 316 will, at some point during the VR experience, fall, at least partially, within the user's sphere 304. The second tree 308 and the car 310 will always fall outside of the user's sphere 304, as the second tree 308 and the car 310 will not be between the left boundary 318 and the right boundary 316 as the user 302 traverses the fixed path. Accordingly, the second tree 308 and the car 310 will be part of the background VR presentation and thus prerendered. Each of first trees (i.e., 306A, 306B, 306C, 306D, and 306E), as well as the house 320 and the box 312, will be at least partially within the user's sphere 304 as the user 302 traverses the fixed path 314. Accordingly, the first trees 306A-E, house 320, and box 312 will be part of the foreground VR presentation and, at least at times, be rendered in real, or near real, time.

Although the discussion of FIG. 3 describes only a VR experience including a fixed path, it should be noted that similar principals can be applied to a VR experience in which the user is allowed more freedom to navigate the virtual world. For example, the VR experience may include a fixed path through the virtual world with the option to visit other areas (e.g., enter structures) along the fixed path, include multiple fixed paths from which the user can select, or allow the user to freely roam the virtual world. Dependent upon the degree of freedom offered to the user, those objects which are outside of the user's sphere will vary. For example, if the user can freely roam the virtual world, only those objects traditionally referred to as a background may be guaranteed to be outside of the user's sphere during the virtual experience.

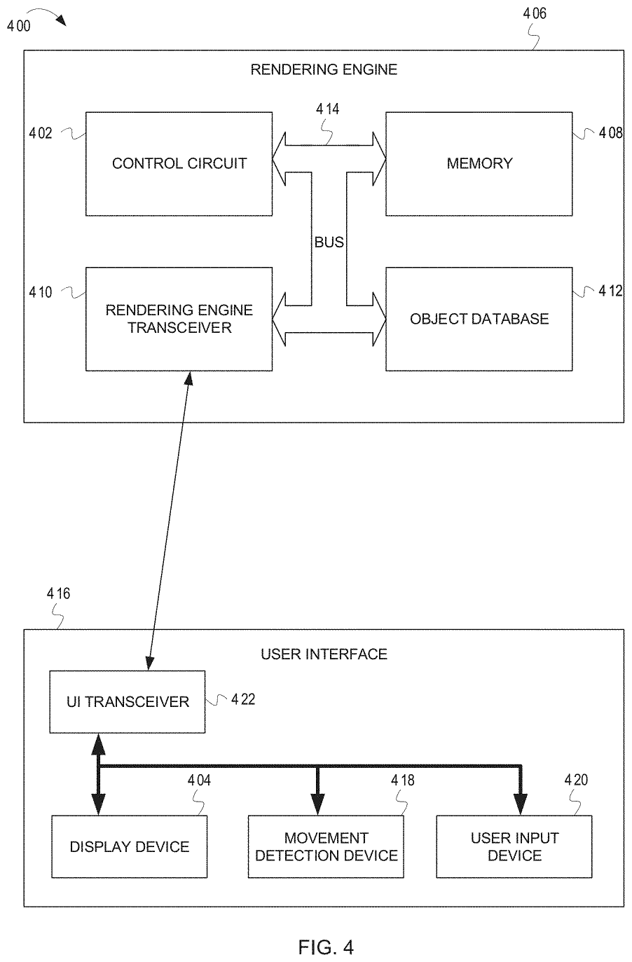

While the discussion of FIG. 3 describes a VR presentation for a dynamic VR experience, the discussion of FIG. 4 provides additional detail regarding a system for generating such a VR presentation.

FIG. 4 is a block diagram of a system 400 for providing a for generating such a VR presentation experience, according to some embodiments. The system 400 a rendering engine 406 and a user interface 416. The rendering engine 406 is communicatively coupled to the user interface 416. The rendering engine 406 includes a control circuit 402, a memory 408, a rendering engine transceiver 410, an object database 412, and a bus 414. The control circuit 402, memory 408, rendering engine transceiver 410, and object database 412 are communicatively coupled via the bus 414.

The object database 412 includes objects that are to be, or can be, presented during the virtual experience. The object database 412 can include logs, files, and other data structures for rendering the objects. In some embodiments, the object database 412 can include a prerendered background VR presentation. The background VR presentation is rendered as an object within the VR presentation, much like any of the other objects in the object database 412.

The control circuit 402 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 402 is configured (for example, by using corresponding programming as will be well understood by those skilled in the art) to carry out one or more of the steps, actions, and/or functions described herein.

By one optional approach the control circuit 402 operably couples to a memory 408. It should be noted that although the memory 408 and the object database 412 are depicted as separate components in FIG. 4, in some embodiments, the memory 408 stored the object database 412. The memory 408 may be integral to the control circuit 402 or can be physically discrete (in whole or in part) from the control circuit 402 as desired. This memory 408 can also be local with respect to the control circuit 402 (where, for example, both share a common circuit board, chassis, power supply, and/or housing) or can be partially or wholly remote with respect to the control circuit 402 (where, for example, the memory 408 is physically located in another facility, metropolitan area, or even country as compared to the control circuit 402).

This memory 408 can serve, for example, to non-transitorily store the computer instructions that, when executed by the control circuit 402, cause the control circuit 402 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The control circuit 402 performs the operations necessary to generate a VR presentation including a background VR presentation and a foreground VR presentation. As previously discussed, the background VR presentation is prerendered. That is, unlike the foreground VR presentation, the background VR presentation is not rendered in real, or near real, time during presentation of the VR presentation. For example, the background VR presentation can be rendered days, months, years, etc. in advance. Preferably, the background VR presentation, once prerendered, can be stored as an object for rendering within the VR presentation. The control circuit 402 determines what objects of the VR presentation to include in the background VR presentation. In one embodiment, the control circuit 402 performs this analysis based on an analysis of pixels in the VR presentation. The control circuit 402, based on the radius of the user's sphere, determines which pixels will not be in the user's sphere during the VR presentation. If a pixel will not be within the user's sphere during the VR presentation, that pixel is included in the background VR presentation. The control circuit 402 generates (i.e., prerenders) the background VR presentation including only those pixels that are not within the user's sphere during the VR presentation.

Just as the control circuit 402 must determine which objects of the VR presentation to include in the foreground VR presentation. In some embodiments, the control circuit performs this analysis based on a frame-by-frame analysis of the VR presentation. During this analysis, the control circuit 402 determines the objects that are not within the user's sphere during the VR presentation. This determination excludes those objects that are, at least temporarily, within the user's sphere during the VR presentation. The control circuit 402 generates the foreground VR presentation. The foreground VR presentation excludes those objects that are not within the user's sphere during the VR experience.

The control circuit 402 renders the VR presentation as a combination of the background VR experience and the foreground VR experience. In some embodiments, the control circuit 402 renders the VR presentation by rendering, in real, or near real, time, the foreground VR presentation and the background VR presentation as an object of the VR presentation. The control circuit 402 renders the VR presentation as the user is interacting with the VR experience. During the VR experience, the control circuit 402 transmits the VR presentation to the display device 404 (e.g., a head mounted display, a television screen, a computer monitor, etc.). As the control circuit 402 is rendering the VR presentation, the control circuit 402 synchronizes the background VR presentation and the foreground VR presentation.

The rendering engine transceiver 410 communicates with the user interface 416, specifically the UI (“user interface”) transceiver 422 to transmit the VR presentation to, and receive input from, the user interface 416. The user interface 416 includes a display device 404 (e.g., a television screen, computer monitor, head mounted display, etc.), a movement detection device 418, and a user input device 420. The display device presents the VR presentation to the user. The movement detection device 418 includes sensors capable of detecting movement. For example, the movement detection device 418 can include a gyroscope to detect an orientation of the display device 404, the user input device 420, etc., light sensors to detect movement relative to external marking lights, position sensors, etc. The data collected by the movement detection device 418 can be transmitted to the rendering engine 406 to allow rendering of the appropriate objects and/or scene based on the user's movement. The user input device 420 allows the user to provide user input and can be a controller or the like. In addition to traditional input mechanisms (e.g., buttons, switches, pads, etc.), the user input device 420 can include sensors capable of detecting movement of the user input device 420.

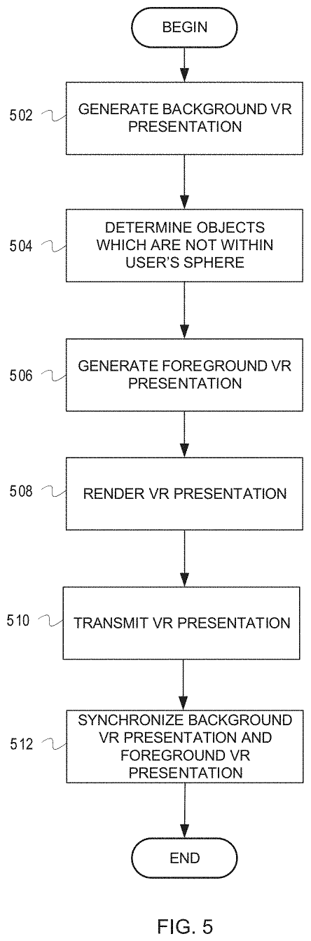

While the discussion of FIG. 4 provides additional detail regarding a system for providing a VR experience, the discussion of FIG. 5 describes example operations for providing a VR experience.

FIG. 5 is a flow chart depicting example operations for providing a virtual reality experience, according to some embodiments. FIG. 5 depicts operations at blocks 502-512. The blocks are examples and are not necessarily discrete occurrences over time (e.g., the operations at different blocks may overlap) and may occur in an order other than that presented. Additionally, the depiction in FIG. 5 is an overview of these example operations. The flow begins at block 502.

At block 502, a background VR presentation is generated. For example, a control circuit can generate the background VR presentation. The background VR presentation is a portion of a larger VR presentation. The VR presentation includes the background VR presentation and a foreground VR presentation. The background VR presentation includes the objects of the VR presentation with which the user cannot interact during the VR experience and/or do not need to be rendered in real time. The control circuit can determine which objects to include in the background VR presentation by any suitable means. For example, the control circuit can analyze which objects, pixels, attributes, etc. of the VR presentation that do not need to be rendered in real time. In one embodiment, this determination is made based upon the distance the objects, pixels, attributes, etc. are from the user during the VR experience. For example, the control circuit can include only those objects, pixels, attributes, etc. in the background VR presentation that are outside of a sphere associated with the user during the VR experience. The flow continues at block 504.

At block 504, it is determined which objects are not within the user's sphere during the VR experience. For example, the control circuit can determine which objects are not within the user's sphere during the VR experience. In one embodiment, the control circuit performs this determination based on the frames of the VR presentation. In such embodiments, the control circuit analyzes each frame to determine whether objects are within the user's sphere. Only those objects that are in the user's sphere during the VR experience are included in the foreground VR presentation. Put another way, the control circuit excludes those objects that are not within the user's sphere during the VR presentation. The flow continues at block 506.

At block 506, the foreground VR presentation is generated. For example, the control circuit can generate the foreground VR presentation. The foreground VR presentation excludes those objects that are not within the user's sphere during the VR presentation. That is, the foreground VR presentation excludes the objects that are part of the background VR presentation. The flow continues at block 508.

At block 508, the VR presentation is rendered. For example, the control circuit can render the VR presentation. As previously discussed, the VR presentation includes both the background VR presentation and the foreground VR presentation. In some embodiments, the control circuit renders the background VR presentation as an object within the VR presentation. During presentation, of the VR presentation, the background VR presentation is presented, for example, on an inner surface of the user's sphere. The flow continues at block 510.

At block 510, the VR presentation is transmitted. For example, the control circuit can transmit (i.e., transmit or cause to be transmitted) the VR presentation. The control circuit transmits the VR presentation to a display device. The display device presents the VR presentation. In some embodiments, the control circuit transmits the VR presentation to the display device during the rendering of the VR presentation. That is, the VR presentation is rendered in real time (i.e., the VR presentation is rendered based on the user's activity during the VR experience). The flow continues at block 512.

At block 512, the background VR presentation and the foreground VR presentation are synchronized. For example, the control circuit can synchronize the background VR presentation and the foreground VR presentation. In some embodiments, one or both of the background VR presentation and the foreground include video and/or moving objects that must be synchronized. In embodiments in which the background VR presentation includes video, the frame rate of the background VR presentation may differ from that of the foreground VR presentation. For example, the background VR presentation may have a frame rate of thirty frames per second (FPS) and the foreground VR presentation may have a frame rate of 90 FPS. In such embodiments, the movement of the video and/or objects must be synchronized. The control circuit synchronizes the background VR presentation and the foreground VR presentation during the rendering of the VR presentation.

In some embodiments, a VR system for providing a VR experience comprises a display device, wherein the display device is configured to present a VR presentation, and a control circuit, wherein the control circuit is communicatively couples to the display device, and wherein the control circuit is configured to generate a background VR presentation, wherein the background VR presentation includes only those pixels that are not within a user's sphere during the VR experience, wherein the user's sphere has a radius which extends from the user during the VR experience, determine, based on an analysis of video frames, objects that are not within the user's sphere during the VR experience, generate a foreground VR presentation, wherein the foreground VR presentation excludes the objects that are not within the user's frame during the VR experience, render a VR presentation, wherein the VR presentation includes a real time rendering of the foreground VR presentation, and wherein the background VR presentation is rendered as an object within the VR presentation, transmit, during the rendering of the VR presentation to the display device for presentation, the VR presentation, and synchronize, during the rendering of the VR presentation, the background VR presentation and the foreground VR presentation.

In some embodiments, an apparatus and a corresponding method performed by the apparatus comprises generating a background VR presentation, wherein the background VR presentation includes only those pixels that are not within a user's sphere during the VR experience, wherein the user's sphere has a radius which extends from the user during the VR experience, determining, based on an analysis of video frames, objects that are not within the user's sphere during the VR experience, generating a foreground VR presentation, wherein the foreground VR presentation excludes the objects that are not within the user's sphere during the VR experience, rendering a VR presentation, wherein the VR presentation includes a real time rendering of the foreground VR presentation, and wherein the background VR presentation is rendered as n object within the VR presentation, transmitting, during the rendering of the VR presentation to a display device for presentation, the VR presentation, and synchronizing, during the rendering of the VR presentation, the background VR presentation and the foreground VR presentation.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A virtual reality (“VR”) system for providing a VR experience, the VR system comprising:
a display device, wherein the display device is configured to present a VR presentation; and
a control circuit, wherein the control circuit is communicatively coupled to the display device, and wherein the control circuit is configured to:
generate a background VR presentation, wherein the background VR presentation includes only those pixels that are not within a user's sphere during the VR experience, wherein the user's sphere has a radius which extends from the user during the VR experience;
determine, based on an analysis of video frames, objects that are not within the user's sphere during the VR experience;
generate a foreground VR presentation, wherein the foreground VR presentation excludes the objects that are not within the user's sphere during the VR experience;
render a VR presentation, wherein the VR presentation includes a real time rendering of the foreground VR presentation, and wherein the background VR presentation is rendered as an object within the VR presentation;
transmit, during the rendering of the VR presentation to the display device for presentation, the VR presentation; and
synchronize, during the rendering of the VR presentation, the background VR presentation and the foreground VR presentation.

2. The VR system of claim 1, wherein the background VR presentation is prerendered.

3. The VR system of claim 1, wherein the VR experience includes a fixed path which the user traverses during the VR experience.

4. The VR system of claim 1, wherein the user can interact with at least some of the objects within the user's sphere during the VR experience.

5. The VR system of claim 1, wherein the background VR presentation is a three hundred sixty-degree video.

6. The VR system of claim 1, wherein the radius is large enough such that the user will not experience a parallax effect for the objects that are not within the user's sphere during the VR experience.

7. The VR system of claim 1, wherein the synchronizing the background VR presentation and the foreground VR presentation is performed for each frame.

8. The VR system of claim 1, wherein the foreground VR presentation includes all objects that enter or pass through the user's sphere during the VR experience.

9. The VR system of claim 1, wherein the foreground VR presentation and the background VR presentation have different frame rates.

10. The VR system of claim 9, wherein the foreground VR presentation has a frame rate of ninety frames per second and the background VR presentation has a frame rate of thirty frames per second.

11. A method for providing a virtual reality (“VR”) experience, the method comprising:
generating a background VR presentation, wherein the background VR presentation includes only those pixels that are not within a user's sphere during the VR experience, wherein the user's sphere has a radius which extends from the user during the VR experience;
determining, based on an analysis of video frames, objects that are not within the user's sphere during the VR experience;
generating a foreground VR presentation, wherein the foreground VR presentation excludes the objects that are not within the user's sphere during the VR experience;
rendering a VR presentation, wherein the VR presentation includes a real time rendering of the foreground VR presentation, and wherein the background VR presentation is rendered as an object within the VR presentation;
transmitting, during the rendering of the VR presentation to a display device for presentation, the VR presentation; and
synchronizing, during the rendering of the VR presentation, the background VR presentation and the foreground VR presentation.

12. The method of claim 11, wherein the background VR presentation is prerendered.

13. The method of claim 11, wherein the VR experience includes a fixed path which the user traverses during the VR experience.

14. The method claim 11, wherein the user can interact with at least some of the objects within the user's sphere during the VR experience.

15. The method of claim 11, wherein the background VR presentation is a three hundred sixty-degree video.

16. The method of claim 11, wherein the radius is large enough such that the user will not experience a parallax effect for the objects that are not within the user's sphere during the VR experience.

17. The method of claim 11, wherein the synchronizing the background VR presentation and the foreground VR presentation is performed for each frame.

18. The method of claim 11, wherein the foreground VR presentation includes all objects that enter or pass through the user's sphere during the VR experience.

19. The method of claim 11, wherein the foreground VR presentation and the background VR presentation have different frame rates.

20. The method of claim 19, wherein the foreground VR presentation has a frame rate of ninety frames per second and the background VR presentation has a frame rate of thirty frames per second.
